(19) United States
(12) Patent Application Publication
(10) Pub. No.: US 2025/0141813 A1
(43) Pub. Date: May 1, 2025

(54) Packet Delays For Time-Deterministic Firewalls

(71) Applicants: HIRSCHMANN AUTOMATION AND CONTROL GMBH, Neckartenzlingen (DE); HOCHSCHULE ESSLINGEN, Esslingen (DE)

(72) Inventors: Tobias HEER, Frickenhausen (DE); Lukas BECHTEL, Stuttgart (DE)

(21) Appl. No.: 18/834,454

(22) PCT Filed: Feb. 17, 2023
(86) PCT No.: PCT/EP2023/054070

§ 371 Date: Jul. 30, 2024

(30) Foreign Application Priority Data
Feb. 18, 2022 (DE) 10 2022 103 926.9

(51) Int. Cl. H04L 47/56; H04L 9/40; H04L 47/28

(52) U.S. Cl. CPC H04L 47/564; H04L 47/28; H04L 63/0236

(57) ABSTRACT

The invention relates to a method for allowing data packets in a network to arrive at the recipient at definable times. The method requires a firewall in a computer network. Each data packet which is transmitted through the firewall to a recipient is assigned a time budget for processing in the firewall. Each data packet is then transmitted to the recipient through the firewall only after the time budget has expired. The time budget is defined based on the maximum possible processing time in the firewall.

The present invention relates to a method for realizing time-deterministic firewalls.

Firewalls are required in computer networks to filter the data packets transmitted in the network and to forward or discard them according to rules.

Packet filters (firewall, switch with ACL rules) examine packets and make decisions based on a set of rules. This set of rules can be stored in the firewall.

The increased volume of real-time traffic means that firewalls must also be able to process packets in real time (i.e., with a specified delay or processing time). The available time budget may be too small for a complete analysis of the packet with regard to all firewall rules. This can depend on the load on the firewall (for example, firewall takes too long because other computing operations were processed with priority) or on parallel processes on the firewall (CPU is being used for something else).

Today, firewalls have no time budgets. As a result, firewalls can forward packets with too much delay/latency, and time-critical packets can arrive too late at the recipient in the network. A strongly varying processing time also causes problems, since this can lead to intermittent packet processing and the accumulation of packets. Therefore, a slower but constant processing time is advantageous in many cases, in particular for the precise prediction and planning of packet flows in the network.

So far, this problem has not been considered more intensively in research, since firewalls have not been used in conjunction with time-critical traffic. This invention describes a method for handling this situation.

Therefore, the object of the present invention is to realize a method for ensuring that time-critical packets arrive at the recipient on a timely basis. Accordingly, the invention sets itself the object of presenting a method for time-deterministic firewalls.

This object is achieved by the features of the main claim.

For this purpose, a method is proposed that ensures that data packets arrive at the recipient in a network at definable times. The aim of the method is to be able to predict the time a data packet needs from the transmitter to the destination in order to control and predict the data traffic in the network using these defined times.

The network includes at least one firewall for this purpose. A time budget is then assigned to each data packet, which is required for processing the data packet in the firewall. The data packet is only transmitted only after the time budget has expired. This means that each data packet is transmitted only after the time budget has expired, regardless of the actual time required for filtering the firewall.

Thus, the time budget itself is based on the maximum possible processing time in the firewall.

In order to achieve a uniform processing time for all packets of a traffic class or a packet stream, it can be useful to delay packets to such an extent that the processing of the firewall rules results in a fixed (but increased) time requirement. Due to the varying load on the firewall, no difference in the processing time can be seen from the outside. As a result, the behavior of the firewall is deterministic and can be planned.

To achieve this behavior, a time budget is assigned to each packet. The time budget is selected in such a way that the firewall has sufficient capacity to always be able to comply with this. Packets are placed in a buffer after processing by the firewall until the time budget has expired. They are then transmitted at a defined point in time. The defined point in time can be defined according to the following criteria:
a) Fixed processing time: Each packet of a traffic class or a packet flow has the same processing time tₘₐₓ. When the packet arrives at the firewall, a time stamp to of the arrival time is taken and stored. The packet is buffered after processing. The packet is then forwarded after t₀+tₘₐₓ. tₘₐₓ is selected so that the processing of the firewall can always be completed within the time tₘₐₓ. Thus, each packet is processed for the fixed time tₘₐₓ. Externally, the firewall has a constant processing time.
b) Clocked forwarding with delay: In order to maintain synchronization with other time-synchronized network devices, it can be useful to always transmit a packet at certain (recurring) points in time. This is also often described as a point in time in a cycle. In addition to method part a), an additional delay can take place, so that the point in time of transmitting the packet can always take place at a recurring fixed point in time t_{send}. For this purpose, a variable delay t_{wait} (extended buffering) is carried out after the delay from point a), so that t₀+tₘₐₓ+t_{wait}=t_{send} for the next transmission window t_{send}.
c) Clocked forwarding without delay: In some cases, it can be advantageous to achieve variable forwarding at certain times without an additional delay by tₘₐₓ. In this case, the firewall has a higher jitter, but at least it transmits at certain points in time of transmission. In this case, the time for buffering and transmitting is selected as follows: t₀+t_{process}+t_{wait}=t_{send}. The time duration t_{process} represents the variable natural processing time of the firewall. Thus, the firewall always forwards the packet as quickly as possible, but at the next defined point in time of transmission t_{send}. The time duration t_{process} can be variable, since it depends on the processing time of the firewall and the number of filter rules.

The maximum wait time tₘₐₓ can either be configured for traffic classes, or it can be determined based on the packet with the matching rules of the firewall. For this purpose, new rules can be introduced in the firewall, which include a reassignment of a time budget tₘₐₓ as the decision. In this way, the time budget can be defined differently for different packets via the firewall rules.

The time budget of the data packets can be assigned according to various criteria. In this way, it is possible to define the time budget according to the traffic class of the network (LAN, WAN, etc.). Likewise, the time budget can be defined according to a property of the data packet (size, content, etc.). The defining of the time budget according to origin or destination (port, network, VLAN, etc.) is also conceivable.

Further features are shown in the attached figures. The following are shown:

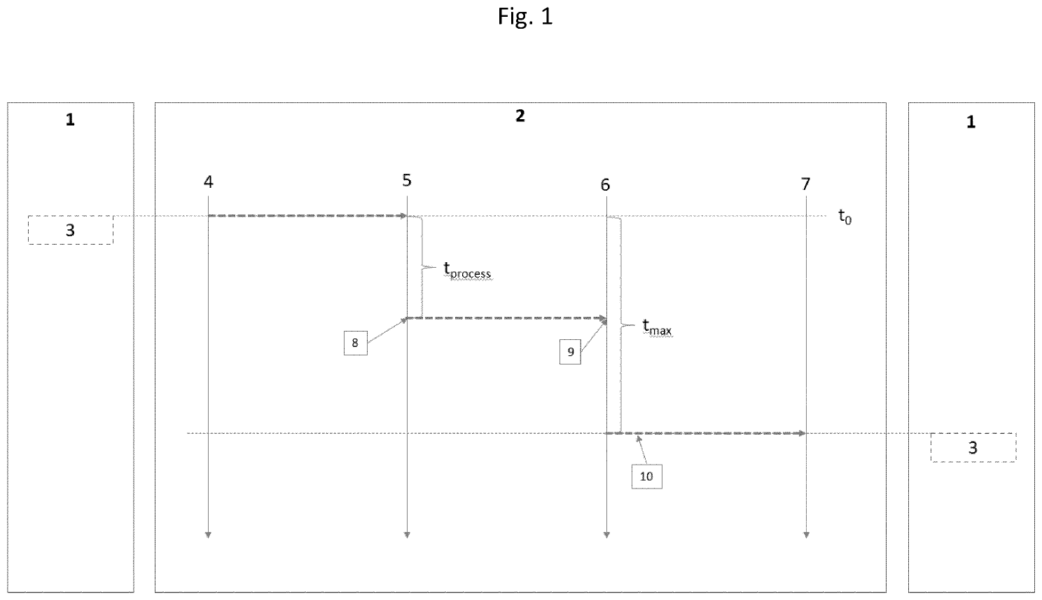

FIG. 1: Time diagram for a transmission delay with a fixed processing time;

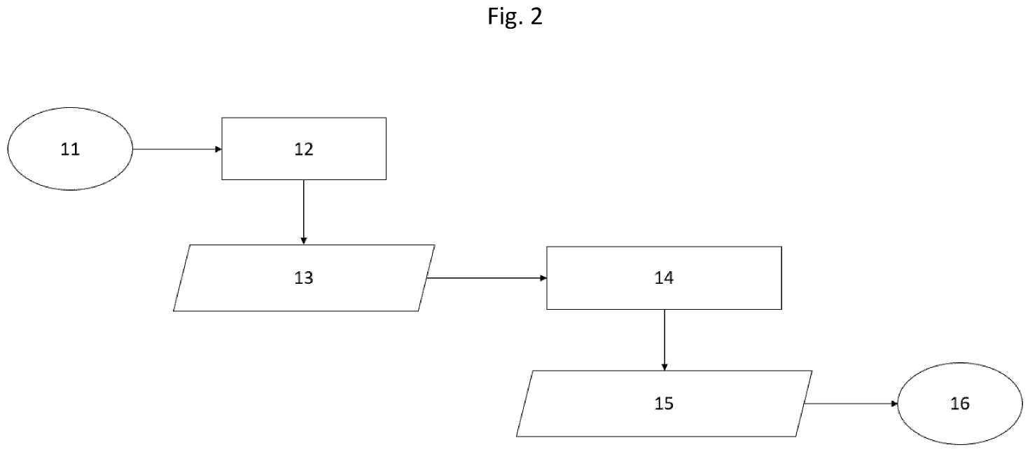

FIG. 2: Block diagram for FIG. 1;

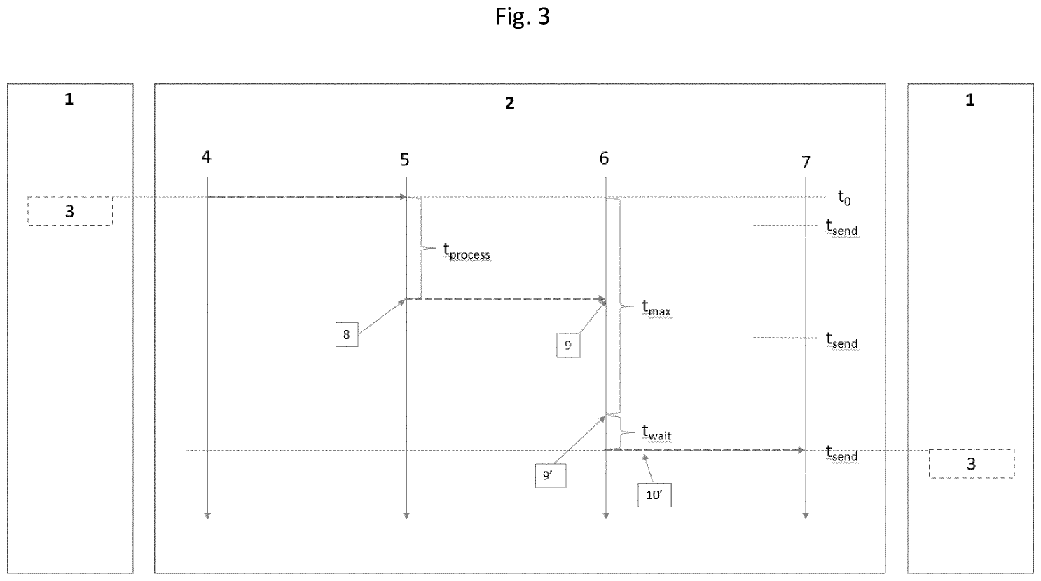

FIG. 3: Time diagram for a transmission delay with clocked forwarding;

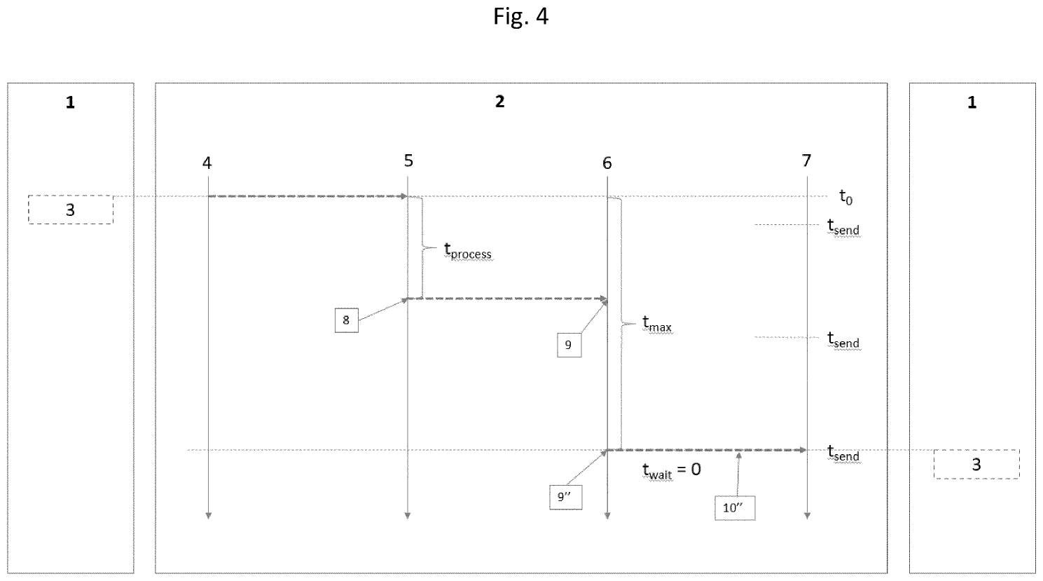

FIG. 4: Time diagram according to FIG. 3, without additional wait time;

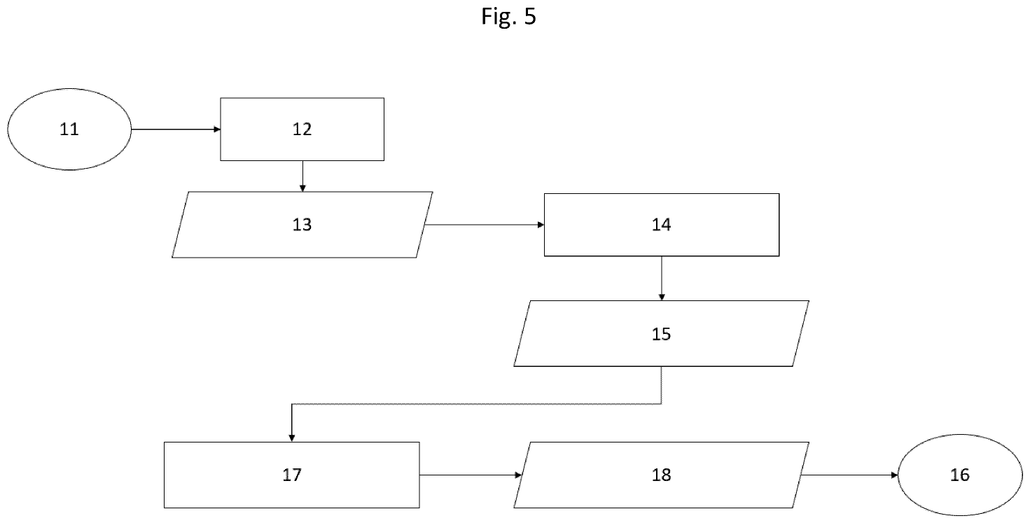

FIG. 5: Block diagram for FIGS. 3 and 4;

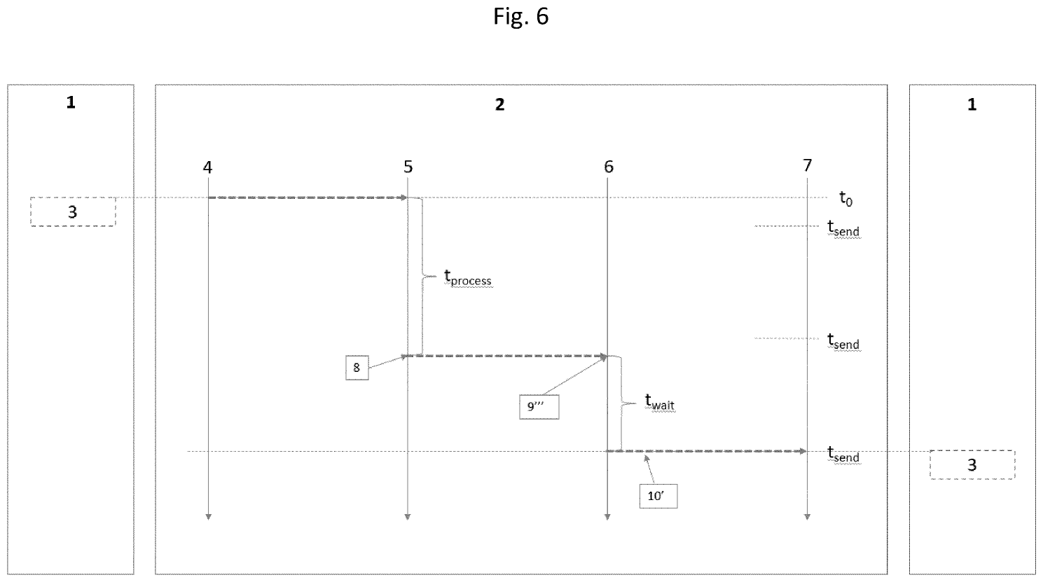

FIG. 6: Time diagram according to FIG. 3, without transmission delay;

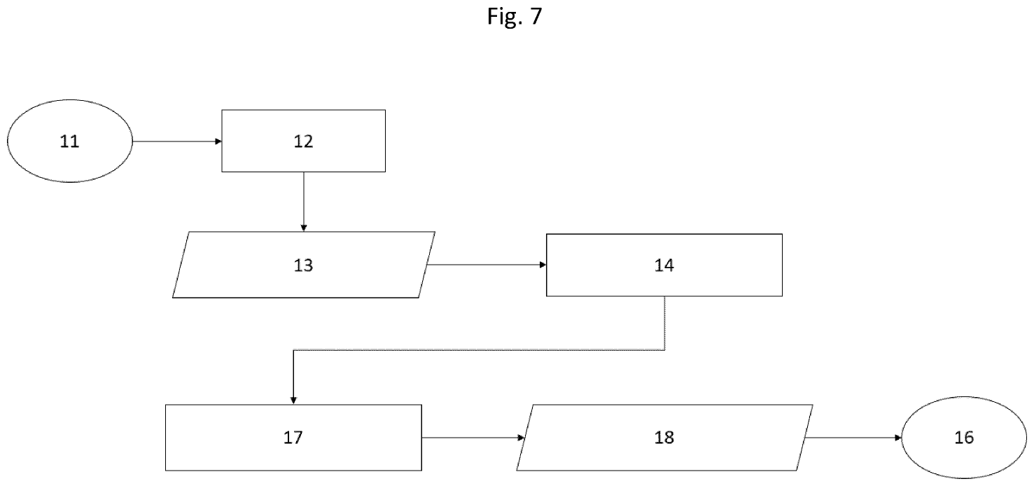

FIG. 7: Block diagram for FIG. 6.

FIG. 1 shows a time diagram of the method according to the invention according to the variant a) described above. Here, a data packet 3 is fed to a firewall 2 in a network 1, in order to be examined according to the rules stored in the firewall 2. The arrival time of the data packet is described with to.

Depending on the number of rules to be processed, the performance of the firewall and the workload of the firewall upon the arrival of the data packet at the input 4 of the firewall, the data packet requires a processing time t_{process}.

Accordingly, the data packet is kept in the processing 5 of the firewall 2 until the rules have been processed and the time t_{process} has thus been completely terminated 8.

In order to bring about time-deterministic behavior, it is now introduced that the data packet 3 reaches a buffer 6 where it is held until a predetermined time tₘₐₓ has expired. This predetermined time is determined by the performance of the firewall along with the maximum working time measured against it, which can occur within the firewall.

After expiration of the time tₘₐₓ, the data packet 3 is then transmitted to the output 7 of the firewall so that the data packet is not transmitted immediately after processing the firewall 3, but is initially buffered 9 and transferred 10 to the output 7 of the firewall and thus further into network 1 only after expiration of the time tₘₐₓ.

FIG. 2 illustrates the method according to FIG. 1 as a block diagram. Here, a data packet or a data frame is initially received by the firewall 11. A time stamp is created or the time of receipt upon arrival 12 at the firewall is specified in a functionally identical manner. Thereafter, filter processing 13 begins through the firewall.

Upon the termination of the filter processing 13, the time is in turn recorded as the processing time 14. This is calculated by subtracting the two recorded times, i.e. the time of arrival 12 of the data packet at the firewall is subtracted from the time after the termination of the filter processing 13. This gives a processing time of 14 t_{process}.

Subsequently, a buffering of the data packet is effected with a wait until the predetermined time tₘₐₓ has expired. After calculating the processing time 14, the difference between tₘₐₓ and t_{process} is waited for, so that the data packet has been processed in the firewall for the maximum time 15 tₘₐₓ.

Subsequently, the data packet is transmitted 16. It can then also be deleted from the buffer. The buffer can be located in the firewall or stored externally in another network participant.

FIG. 3 shows a time diagram of the method according to the invention according to the variant b) described above. Here, a data packet 3 is fed to a firewall 2 in a network 1, in order to be examined according to the rules stored in the firewall 2. The arrival time of the data packet is described with to.

Depending on the number of rules to be processed, the performance of the firewall and the workload of the firewall upon the arrival of the data packet at the input 4 of the firewall, the data packet requires a processing time t_{process}.

Accordingly, the data packet is kept in the processing 5 of the firewall 2 until the rules have been processed and the time t_{process} has thus been completely terminated 8.

In order to bring about time-deterministic behavior, it is now introduced that the data packet 3 reaches a buffer 6, where it is held until a predetermined time tₘₐₓ has expired. This predetermined time is determined by the performance of the firewall along with the maximum working time measured against it, which can occur within the firewall.

However, in contrast to FIG. 1, the data packet is not transmitted after expiration of time tₘₐₓ, but a clocked, periodically repeating time t_{send} is defined at which data packets defined by the firewall are transmitted. As a result, calculable times at which data packets can be transmitted arises.

After expiration of the time tₘₐₓ, the data packet 3 is not transmitted to the output 7 of the firewall, but another buffering 9′ is carried out, which lasts until the next t_{send}. This additional wait time is defined with t_{wait}. Only when the next t_{send} is reached and thus after expiration of the time t_{wait} does the transfer 10′ take place to the output 7 of the firewall and hence further into the network 1.

FIG. 4 shows a further variant of the method shown in FIG. 3. Here, the predetermined time tₘₐₓ falls exactly at the point in time of t_{send} so that no further buffering 9″ needs to take place. In this case, the data packet 3 can be transferred 10″ immediately, without applying a wait time t_{wait}.

FIG. 5 illustrates the method according to FIGS. 3 and 4 as a block diagram. Here, a data packet or a data frame is initially received by the firewall 11. A time stamp is created or the time of receipt upon arrival 12 at the firewall is specified in a functionally identical manner. Thereafter, filter processing 13 begins through the firewall.

Upon the termination of the filter processing 13, the time is in turn recorded as the processing time 14. This is calculated by subtracting the two recorded times, i.e. the time of arrival 12 of the data packet at the firewall is subtracted from the time after the termination of the filter processing 13. This gives a processing time of 14 t_{process}.

Subsequently, a buffering of the data packet is effected with a wait until the predetermined time tₘₐₓ has expired. After calculating the processing time 14, the difference between tₘₐₓ and t_{process} is waited for, so that the data packet has been processed in the firewall for the maximum time 15 tₘₐₓ.

Now, the next t_{send} is waited for. The data packet 3 is held in the buffer for this long. The wait time t_{wait} can be determined 17 as follows: t_{wait}=t_{send}−(t₀+tₘₐₓ). This wait time is waited 18 until the data packet is forwarded.

Subsequently, the data packet is transmitted 16. It can then also be deleted from the buffer. The buffer can be located in the firewall or stored externally in another network participant.

FIG. 6 shows a time diagram of the method according to the invention according to the variant c) described above. Here, a data packet 3 is fed to a firewall 2 in a network 1, in order to be examined according to the rules stored in the firewall 2. The arrival time of the data packet is described with to.

Depending on the number of rules to be processed, the performance of the firewall and the workload of the firewall upon the arrival of the data packet at the input 4 of the firewall, the data packet requires a processing time t_{process}.

Accordingly, the data packet is kept in the processing 5 of the firewall 2 until the rules have been processed and the time t_{process} has thus been completely terminated 8.

In order to bring about time-deterministic behavior, it is now introduced that the data packet 3 reaches a buffer 6, where it is initially held.

For this purpose, a clocked, periodically repeating time t_{send} at which data packets are transmitted by the firewall is defined. As a result, calculable times at which data packets can be transmitted arises.

After the time t_{process} has expired, the buffering 9″ of the data packet occurs in the buffer 6, which lasts until the next t_{send}. This additional wait time is defined with t_{wait}. Only when the next t_{send} is reached and thus after expiration of the time t_{wait} does the transfer 10′ take place to the output 7 of the firewall and further into the network 1.

In contrast to the variant from FIGS. 3 and 4, there is no need to wait for tₘₐₓ.

FIG. 7 illustrates the method of FIG. 6 as a block diagram. Here, a data packet or a data frame is initially received by the firewall 11. A time stamp is created or the time of receipt upon arrival 12 at the firewall is specified in a functionally identical manner. Thereafter, filter processing 13 begins through the firewall.

Upon the termination of the filter processing 13, the time is in turn recorded as the processing time 14. This is calculated by subtracting the two recorded times, i.e. the time of arrival 12 of the data packet at the firewall is subtracted from the time after the termination of the filter processing 13. This gives a processing time of 14 t_{process}.

Now the next t_{send} is waited for. The data packet 3 is held in the buffer for this long. The wait time t_{wait} can be determined 17 as follows: t_{wait}=t_{send}-(t₀+tₘₐₓ). This wait time is waited 18 until the data packet is forwarded.

Subsequently, the data packet is transmitted 16. It can then also be deleted from the buffer. The buffer can be located in the firewall or stored externally in another network participant.

### LIST OF REFERENCE SIGNS

1 Network
2 Firewall
3 Data packet
4 Input
5 Processing
6 Buffer
7 Output
8 Rule processing terminated
9 Start of buffering
9′ Further buffering
9″ No further buffering
9′″ Buffering until point in time of transmission
10 Transfer
10′ Transfer after wait time
10″ Transfer without wait time
10′″ Transfer after wait time
11 Receipt
12 Arrival
13 Filter processing
14 Processing time
15 Maximum time
16 Transmission
17 Wait time determined
18 Wait time waited

1.-14. (canceled)

15. A method for allowing data packets in a network to arrive at the recipient at definable times, with a firewall in a computer network, wherein:
each data packet is assigned a time budget for processing in the firewall,
each data packet is transmitted only after the time budget has expired, and
the time budget is defined based on the maximum possible processing time in the firewall.

16. The method according to claim 15, wherein the processing time of the firewall comprises the time from the input of a data packet at the firewall via the processing to the output of the data packet at the firewall.

17. The method according to claim 16, wherein the processing time additionally includes a buffer time during which the data packet is held in a buffer.

18. The method according to claim 15, wherein the time budget for processing the data packet in the firewall corresponds to a definable maximum time which is greater than the maximum processing time to be expected.

19. The method according to claim 18, wherein the data packet is transmitted to the output of the firewall after the defined maximum time has expired.

20. The method according to claim 15, wherein a periodically repeating transmission time is defined, and the transmission of the data packet to the output of the firewall only takes place at these transmission times.

21. The method according to claim 20, wherein the time budget for processing the data packet in the firewall corresponds to a definable maximum time, which is greater than the maximum processing time to be expected, along with a wait time, which is determined by the time after the processing time until the next transmission time.

22. The method according to claim 21, wherein the data packet is transmitted to the output of the firewall after the defined maximum time and the wait time have expired.

23. The method according to claim 21, wherein the event that the expiration of the maximum time falls at the same point in time as a transmission time, the wait time is equal to 0.

24. The method according to claim 20, wherein the time budget for processing the data packet in the firewall corresponds to the processing time, along with a wait time, which is determined by the time after the processing time until the next transmission time.

25. The method according to claim 24, wherein the data packet is transmitted to the output of the firewall after expiration of the processing time and the wait time.

26. The method according to claim 15, wherein a time recording of the data packets takes place upon arrival at the input of the firewall.

27. The method according to claim 15, wherein the processing time corresponds to the time required by the filter processing of the firewall for one data packet.

28. The method according to claim 15, wherein the buffer is arranged in the firewall.
